(19) United States
(12) Patent Application Publication
(10) Pub. No.: US 2011/0072038 A1
(43) Pub. Date: Mar. 24, 2011

(54) WEB SITE WITH CONTENT BASED ON REFERRING LINK INFORMATION

(76) Inventor: Daniel Burge, Wylie, TX (US)

(21) Appl. No.: 12/886,458

(22) Filed: Sep. 20, 2010

Related U.S. Application Data
(60) Provisional application No. 61/243,784, filed on Sep. 18, 2009.

(51) Int. Cl. G06F 17/30

(52) U.S. Cl. 707/769; 707/E17.014

(57) ABSTRACT

Custom content for a website is communicated to a user computer responsive to receiving a request at a hosting computer from the user computer to access the website. If the request contains keywords from a previous search request initiated at the user computer, it is determined whether the keywords set forth in the request match an entry in a database associating certain sets of keywords to specific content for display on a user computer. If so, the specific content is communicated to the user computer responsive to the match.

### CROSS-REFERENCE TO RELATED APPLICATIONS

This application claims the benefit of the filing date of copending provisional application U.S. Ser. No. 61243784, filed Sep. 18, 2009, entitled “DYNAMIC INSERTION OF SEARCH/REFERRER RELEVANCE INTO WEB SITE”, which is incorporated by reference herein.

### STATEMENT OF FEDERALLY SPONSORED RESEARCH OR DEVELOPMENT

Not Applicable

### BACKGROUND OF THE INVENTION

1. Technical Field

This invention relates in general to Internet web sites and, more particularly, to a method of enticing users to explore a web page.

2. Description of the Related Art

The Internet has now replaced many aspects of information retrieval in everyday life. While guides to finding goods and services still exist in paper form, such as the Yellow Pages or manufacturer guides, the Internet provides the most efficient structure for finding information quickly and in large volume.

However, the ability to have a large amount of information about a particular business (or other topic) on the Internet often leads to the user feeling that he or she may have gone to the wrong page. Typically, information on the Internet is found in two primary ways. The first is by performing a search on relevant terms. For example, if a person in Dallas has a problem with a leaky faucet in Dallas, Tex., he or she might search on the terms “fix leaky faucet Dallas Tex.”. There are many different types of search engines, and each search engine uses it own algorithm for finding pertinent information using the search terms entered by the users. Typically, with multiple terms, the search engines will try to find matches with all the terms first, then find matches with subsets of the terms in descending order. So, in the example above, the search engine would likely find links to “fix leaky faucet” that pertained to do-it-yourself plumbing, links to plumbers outside of Dallas, links to articles by non-plumbers about troubles with a leaky faucet, and so on.

To help a user find a link, search results usually contain a “snippet”, which is a small part of the text from the site, sometimes parsed, which shows the search terms in context. The words in the snippet, however, may be buried in the text on the cited page, or not viewable at all.

When a user jumps to the web site linked by one of the search results, it is very possible that the keywords are not apparent on the linked page. Because information is so easily obtained using the searches, users often become impatient if they don't what they are looking for immediately. Thus, if the user jumps to a web page that largely promotes pipe unclogging rather than fixing leaky faucets, he or she may assume that the focus of the vendor is in a related field and go back to find another more appropriate vendor.

The second way that a user may find a particular web site is through another web page. The referring web page could be, for example, a directory of vendors, or an information article on the subject, or an advertisement placed on the referring website. Once again, if a user doing research on a subject, such as local plumbers for fixing leaky faucets, does not readily observe the subject on the referred page, he or she navigate away from the page and either return to the article or go to a search engine in order to find more relevant information.

Accordingly, a need has arisen for a more effective method of promoting a web page.

### BRIEF SUMMARY OF THE INVENTION

In the present invention, content for a website is communicated to a user computer responsive to receiving a request at a hosting computer from the user computer to access the website. If the request contains keywords from a previous search request initiated at the user computer, it is determined whether the keywords set forth in the request match an entry in a database associating certain sets of one or more keywords to specific content for display on a user computer. If so, the specific content is communicated to the user computer responsive to the match.

The present invention provides significant advantages. First, it clearly alerts the user that the website contains relevant information concerning the users search. Second, it can provide content appropriate to the search, including text, images, video, and sound.

### BRIEF DESCRIPTION OF THE SEVERAL VIEWS OF THE DRAWINGS

For a more complete understanding of the present invention, and the advantages thereof, reference is now made to the following descriptions taken in conjunction with the accompanying drawings, in which:

FIG. 1 illustrates a block diagram showing the network structure used in implementing the preferred embodiment of the present invention;

FIG. 2 illustrates a user interface for entering associations between keyword sets or URLs and custom content;

FIG. 3 illustrates an example of a user search;

FIG. 4 illustrates an example of a possible result of the search of FIG. 3;

FIG. 5 illustrates a web site with custom content insertion based on the referring keywords or URL;

FIG. 6 illustrates a different search string from that of FIG. 3;

FIG. 7 illustrates the results from the search of FIG. 6;

FIG. 8 illustrates the different customized content insertion for the search string of FIG. 6.

### DETAILED DESCRIPTION OF THE INVENTION

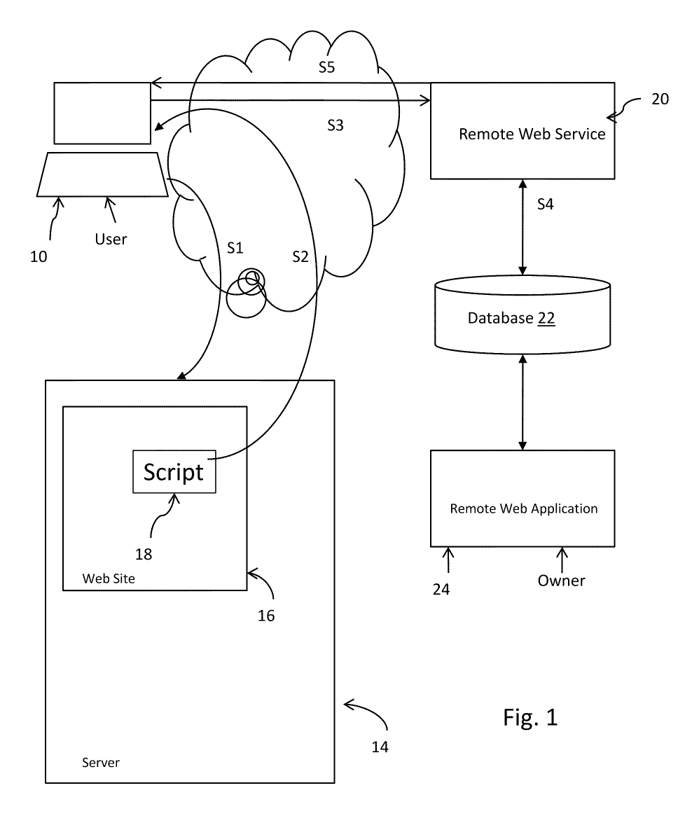

The present invention is best understood in relation to FIGS. 1-8 of the drawings, like numerals being used for like elements of the various drawings.

The present invention dynamically inserts content into a web site in response to a request for access to the site from a user computing device. The content is dependent upon one or more terms used in a search which provided the link to the web site and/or to the referring web site. Accordingly, when the web page is sent to the user computer, content has been specifically provided on the website to grab the attention of the user based on either the keywords used in the search or the identity of the referring website.

FIG. 1 illustrates a basic block diagram of the network structure used to provide the custom content. While it is assumed that the Internet is used for all or part of the communications between computers, the invention could work on any structure of networked computing devices, including public and private network systems, or combinations thereof, for communicating data. A user, in conjunction with user computing device 10, is looking for information regarding a certain subject. User computing device 10 could be any type of processing device with network browsing capabilities, such as a personal computer, tablet computer, smart phone, or other mobile or other device with browsing capabilities.

In the search for information, the user 10 will likely use search engines, such as Google, Yahoo, or Microsoft Bing, or go to general informational sites, such as Wikipedia, or more specific informational sites, such as a do-it-yourself site, like HGTV.com. When the user clicks on a link from a referring website (either a search engine site or other web page), the user computer 10 makes a connection request to a referred web site 16 (which may be implemented on privately owned computer or hosted on a shared computer 14) by passing a request string (e.g., the http “referer” header) to the referred website 16. This string includes, among other information the URL (universal resource locator) of the referring page. If the referring website is a search engine, the URL will include the keywords used for the search. For example, a URL in the request header for a search on “nfl football” might be:

“http://www.google.com/search?q=nfl+football&ie=utf-8&oe=utf-8&aq=t&rls=org.mozilla:en-US:official&client=firefox-a”

In the above example, the string immediately after “q=” provides the search terms. The exact structure of the URL is dependent upon the search provider. The http referer header is controlled by standards organization W3C (www.w3.org); the particulars of the present day referer header are not important; the invention could be used with any request that passes keywords and referring URLs directly or indirectly.

In the preferred embodiment of the invention, the referred website 16 uses an embedded script tag 18 in conjunction with a remote web service 20, database 22 and a remote web application 24 to display customized information on the user computer 10 in response to the connection request between the user computer 10 and the website 16 (step S1). The website 16 will return the code associated with the requested web page to the user computer 10; this web page will include the script tag 18 (step S2). When the web page code is executed to display the requested page, the script tag 18 passes the referer header to the remote web service 20 (if the referer header is not null or blank) (step S3). From the contents of the referer header, the remote web service determines: (1) whether the URL indicates a supported search engine, and (2) if the URL indicates a supported search engine, what are the keywords in the search string.

Sample code for the script tag is given below:

<!--http://www.ClickAndStick.com DO NOT EDIT BELOW THIS
LINE-->
<script language=“javascript” type=“text/javascript”
id=“ClickAndStick_Initialize”>
<!--
if(document.referrer != null && document.referrer != “”){
document.write(unescape(“%3Cdiv
id=‘ClickAndStick_Content’%3E%3C/div%3E”));
document.write(unescape(“%3Cscript id=‘ClickAndStick_Data’
src=‘http://content.clickandstick.com/s/s.aspx?uid=f28174b1-e1b4-4ceb-
a73b-22e98b87ace0&amp;url=”) + escape(document.referrer) +
unescape(“’type=‘text/javascript’%3E%3C/script%3E”));
}
// -->
</script>
<!--http://www.ClickAndStick.com DO NOT EDIT ABOVE THIS
LINE-->

If the referer header does not include a URL, the web service 20 is finished, and the browsing continues as normal. Otherwise, a search of database 22 is initiated to determine if custom content exists for the keyword or URL (step S4); if so, the custom content is retrieved from the database 22 and communicated to the user computer 10 (step S5). If the referer header includes a URL that is not one of the supported web engines, then the remote web service 20 initiates a search for the URL on database 22. If the referer header includes a URL with a supported search engine, then the URL is parsed to determine which keywords were used in the search by the user and a search of the database 22 is initiated using the keywords.

The remote web application 24 allows the owner of the website 16 to define associations between web content (including text, HTML coding, images, animations, video and any other resource that can affect what the user sees on the website, or how the website reacts to input from the user) and particular keywords or groups of keywords or the identity of the referring website. These associations are stored in database 22. The associations can be modified as desired via the remote web application 24.

In operation, the referer header is passed to the remote web service 20 if the referer header includes keyword or URL information. The remote web service 20 queries the database 22 to determine whether this information matches an entry in the database. If so, the remote web server retrieves the custom content from the database 22 and sends it to the user's web browser. The custom content may vary based on the matching keywords—for example, a company that does both custom web development and hosting services may wish to provide video showing their development capabilities, but only images and text for the hosting services.

The custom content from the database 22 (if any) can either be places at the location where the script tag is placed (the “inline” method), or, alternatively, an overlay window can be created at a location specified in the database.

The actions described above re-occur each time a web page including the embedded script is accessed via a search term or a referring website. By placing the script tag in the html header, one script can work for an entire site. Alternatively, the script can be placed in desired pages in the website by placing the script tag in the body portion of the html for that page.

In addition to updating the web page content, the web service 20 also tracks the keywords and referring sites, whether or not there is a matching entry in the database 22, and maintains this information in a database (which can be the same or separate from database 22) for the website owner. Each instance is tracked so that the owner may identify the most popular ways in which the website 16 is being accessed. The owner can then use this information to identify which opportunities are available for providing customized content. Additionally, the owner can define its own keyword sets or referring URLs for which to define content.

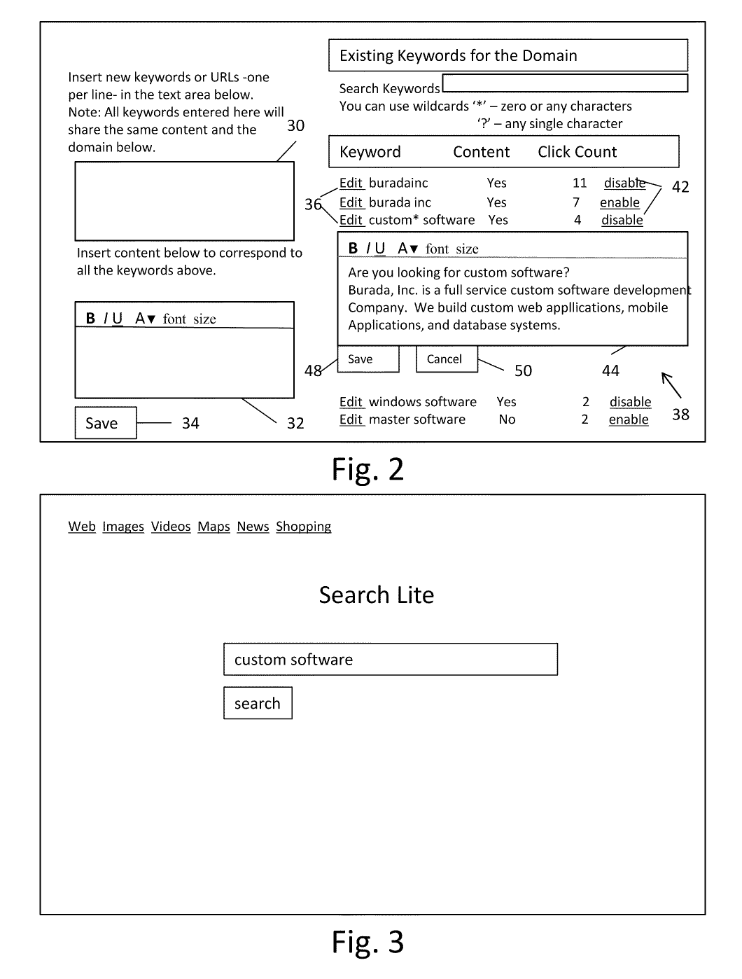

The invention is described in detail in connection with FIGS. 2-6. FIG. 2 shows an example of an interface provided by remote web application 24 for recording records defining the associations for a particular web page or web site. A new keyword/URL box 30 is used to enter one or more keywords or URLs to create a new record. Matching for keywords could be determined using well know methods, and wildcards could be used as well. For example, “custom*” would match both “custom” and “customized”. An associated content box 32 receives information defining the content to be displayed in response to a match involving the keywords in new keyword box 30. When the Save button 34 is pressed, the keywords and content are placed into a record 36 in the database 22.

Existing database records 36 are shown in table 38. Any record can be modified by pressing the associated “Edit” button 40, and an association defined by a record can be either enabled or disabled by pressing the associated “enable/disable” button 42. When disabled, the keyword string (or URL) will not be used to determine what content is displayed.

In FIG. 2, the keyword string “custom software” is being edited. An edit box 44 similar to content box 32 is used to edit the content associated with the search terms. Alternatively, the owner can choose existing content associated with another keyword stream to place in the edit box 44, using drop-down box (not shown). The changes to the content can be saved using Save key 48 or reverted back to the original content using Cancel key 50.

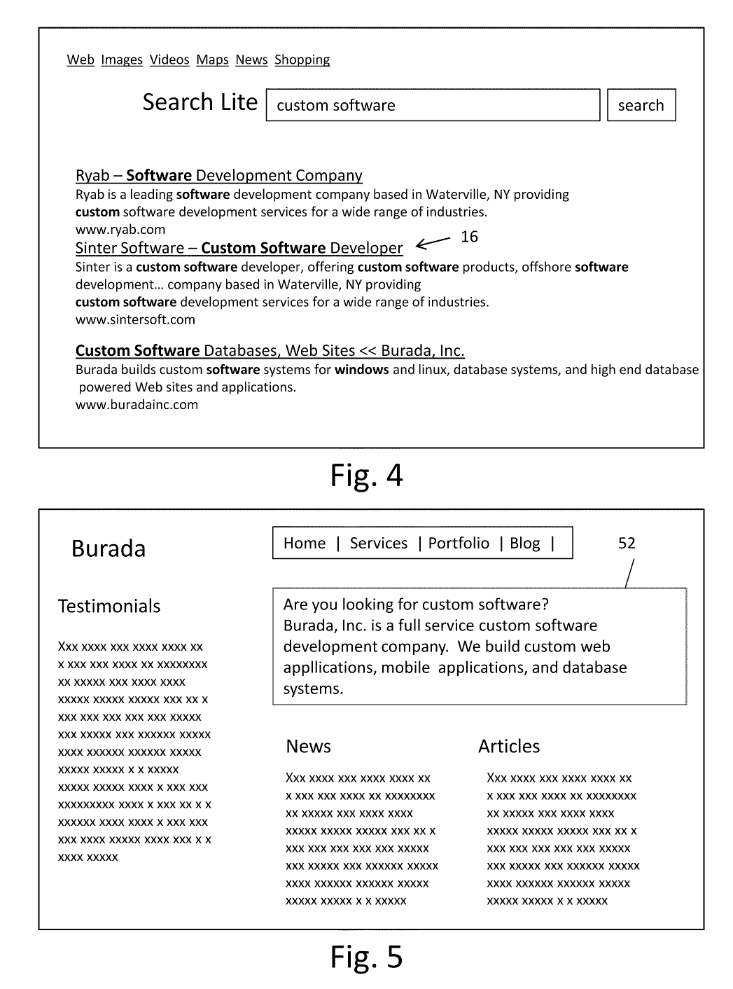

FIG. 3 illustrates a typical search performed by a user—in this instance using the Google search engine. In this illustration, “custom software” has been entered by the user. When the user pressed “enter” on the computer keyboard, or “Search” on the search screen, the search engine will find matching sites, as shown in FIG. 4.

In FIG. 4, a website 16 using the invention is provided in the search results. When the user presses on this link, the browser software on the user's computing device will initiate actions to create a communication path between the user's computing device 10 and the web site 16. This is referred to as a “clickthrough”.

In FIG. 5, the web site 16 displays shows the custom content from the database 22 associated with keywords “custom software” in a content box 52, the location of which could be defined by the location of the script tag or in the database 22. In the illustrated embodiment, text describing the custom software aspects of the owner are shown; however, any content could be used to further attract the user, such as a video about custom software development or a mailform to get more information about an aspect of custom software development.

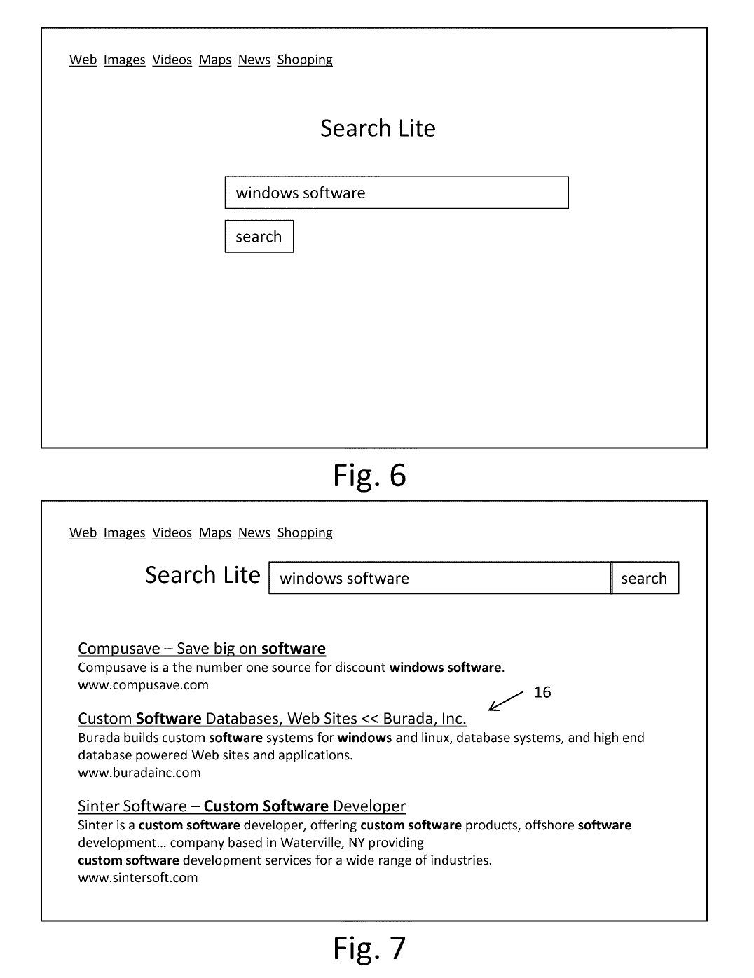

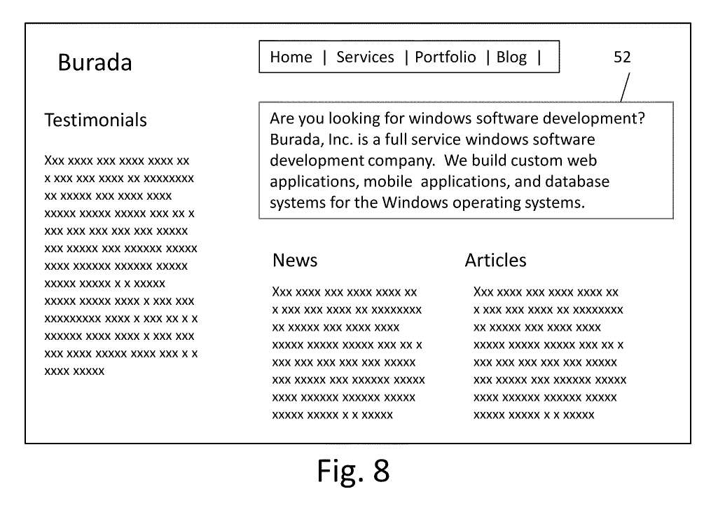

If FIG. 6, a slightly different keyword string is entered —“window software”. Again, the search results in a link in the results page shown in FIG. 7. However, in FIG. 8, the customized content box now shows different content in box 52 directed towards Windows software development.

The present invention could be used in a number of ways to improve web site efficiency. As shown in the example above, the invention can be used to improve the informational aspects of a web site by indicating that the owner provides the goods or services searched for by the user. Additionally, the invention could be used situationally, for example where a user is searching for a particular product, the custom content could provide a coupon code for the product, taking advantage of the knowledge that the user is already predisposed to buying the product. The invention could also be used to facilitate navigation of the website. For example, the custom content to include one or more links to the most relevant pages of the website to help the user find the requested information.

Although the Detailed Description of the invention has been directed to certain exemplary embodiments, various modifications of these embodiments, as well as alternative embodiments, will be suggested to those skilled in the art. The invention encompasses any modifications or alternative embodiments that fall within the scope of the Claims.

I claim:

1. A method of providing content on a web site of a user computer comprising the steps of:
receiving a request at a hosting computer from the user computer to access a website;
determining whether the request contains keywords from a previous search request initiated at the user computer;
if the request contains keywords, determining whether the keywords set forth in the request match an entry in a database associating certain sets of one or more keywords to specific content for display on a user computer;
communicating the specific content to the user computer responsive to the match.

2. The method of claim 1 wherein the step of receiving a request comprises the step of receiving a http referer header sent from the user computer.

3. The method of claim 1 wherein the determining step comprises the step of determining whether the request includes a header specifying a search engine website and, if so, identifying keywords from the header.

4. The method of claim 3 wherein keywords are identified responsive to the identified search engine.

5. The method of claim 1 and further comprising the step of determining whether the request was initiated by a hyperlink on a referring website.

6. The method of claim 5 and further comprising the steps of:
determining a name associated with the referring website;
determining whether the name of the referring website matches an entry in the database; and
communicating specific content to the user computer responsive to a match between the name of the referring website and an entry in the database.

7. The method of claim 1, wherein a script is placed on the website to forward the request to a remote web service.

8. The method of claim 7, wherein the remote web server sends the content to the user computer.
